(19) United States
(12) Patent Application Publication
(10) Pub. No.: US 2022/0222465 A1
(43) Pub. Date: Jul. 14, 2022

(54) CAMERA ASSEMBLY FOR A FACIAL RECOGNITION SYSTEM OF A MOTOR VEHICLE

(71) Applicant: DUS Operating Inc., Auburn Hills, MI (US)

(72) Inventors: Arnaud Thooris, Le Kremlin Bicetre (FR); Francis Delavigne, Ollainville (FR); Lionel Bitauld, Gif-sur-Yvette (FR); Eric Durand, Louveciennes (FR)

(21) Appl. No.: 17/231,364

(22) Filed: Apr. 15, 2021

Related U.S. Application Data
(60) Provisional application No. 63/136,016, filed on Jan. 11, 2021.

(51) Int. Cl. G06K 9/00; B60R 25/30; B60R 25/25; B60R 25/01; B60R 11/04; H04N 5/33; E05F 15/73

(52) U.S. Cl. CPC G06K 9/00255; B60R 25/305; B60R 25/25; B60R 25/01; B60R 2011/0022; H04N 5/33; G06K 9/00288; E05F 15/73; B60R 11/04

(57) ABSTRACT

A camera assembly is provided for a facial recognition system of a motor vehicle. The camera assembly includes a cosmetic panel adapted to be attached to the motor vehicle. The cosmetic panel has an outboard side and an inboard side facing the motor vehicle. The cosmetic panel is opaque to visible light and transmissive to an infrared light. The camera assembly further includes a single infrared camera adapted to be disposed adjacent to the inboard side of the cosmetic panel. The single infrared camera generates an image signal, in response to the single infrared camera receiving the infrared light transmitted through cosmetic panel.

### FIELD

The present disclosure relates to facial recognition systems for motor vehicles, and more particularly, to a camera assembly for a facial recognition system that includes a cosmetic panel concealing an infrared camera.

### BACKGROUND

Modern vehicles can have complex display systems with multiple exterior-facing cameras to view vehicle surroundings. Drivers often compensate for the viewing angle restricted by the A-pillars and B-pillars by adjusting their position while driving. For this reason, the system can include the exterior-facing cameras mounted on the outside of the vehicle to send images from the immediate vehicle environment to displays, which are integrated into the A-pillars and B-pillars inside the car. The live recordings of the external cameras, in conjunction with the recording of the driver's head movements, offer the driver a dynamic perspective of the vehicle's surroundings. This system opens up a spatial field of vision that is intended to look more like a view through an extended window than a video recording. Because these cameras capture live videos that must be displayed to the driver, the cameras are RGB cameras that must be covered by transparent panels such that light in the visible spectrum from the vehicle's surroundings can transmit through the panels to the RGB cameras. Unfortunately, the cameras can be seen through the transparent panels and substantially interrupt the cosmetic appearance of the vehicle. In addition, the view captured by the RGB cameras can be obstructed by fog, smoke, blowing dust, and poor lighting. While these systems assist a driver with viewing surroundings that could have been obscured by piilars, these systems do not assist with facial recognition for determining authority to enter a vehicle.

Accordingly, there is a need for a camera assembly for a facial recognition system that selectively permits entry into a motor vehicle without the cameras being visible from the surroundings of the vehicle.

### SUMMARY

According to several aspects, a camera assembly is provided for a facial recognition system of a motor vehicle. The camera assembly includes a cosmetic panel adapted to be attached to the motor vehicle. The cosmetic panel has an outboard side and an inboard side facing the motor vehicle. The cosmetic panel is opaque to visible light and transmissive to an infrared light. The camera assembly further includes a single infrared camera adapted to be disposed adjacent to the inboard side of the cosmetic panel. The single infrared camera generates an image signal, in response to the single infrared camera receiving the infrared light transmitted through cosmetic panel.

In one aspect, the cosmetic panel includes a peripheral edge that defines a perimeter and an intermediate portion spaced from the perimeter. The single infrared camera is attached to the intermediate portion, such that the cosmetic panel covers the infrared camera.

In another aspect, the camera assembly further includes a header for attaching the single infrared camera to the intermediate portion of the cosmetic panel.

In another aspect, the camera assembly further includes an infrared illuminator disposed adjacent to the single infrared camera for emitting the infrared light through the intermediate portion of the cosmetic panel, such that an object facing the outboard side of the cosmetic panel reflects the infrared light back through the intermediate portion to the infrared camera.

In another aspect, the cosmetic panel is a single-piece panel having an opacity that blocks visible light and a translucence for transmitting the infrared light.

In another aspect, the cosmetic panel is a poly(methyl methacrylate) (PMMA) material.

In another aspect, the cosmetic panel is a composite including germanium and/or silicon.

According to several aspects, a motor vehicle includes a body and a door, which is attached to the body and movable between open and closed positions. The motor vehicle further includes a lock device that is coupled to at least one of the door and the body. The lock device is movable to a locked state for holding the door in the closed position and an unlocked state where the door is movable to the open position. The motor vehicle further includes an actuator for moving the lock device between the locked and unlocked states. The motor vehicle further includes a facial recognition system having a camera assembly. The camera assembly includes a cosmetic panel that is adapted to be attached to one of the door and the body. The cosmetic panel has an outboard side and an inboard side facing one of the door and the body. The cosmetic panel is opaque to visible light and transmissive to an infrared light. The camera assembly further includes a single infrared camera that is adapted to be disposed adjacent to the inboard side of the cosmetic panel. The single infrared camera generates an image signal, in response to the single infrared camera receiving the infrared light transmitted through cosmetic panel. The facial recognition system further includes a processor coupled to the infrared camera. The facial recognition system further includes a memory including instructions, such that the processor is programmed to determine an image in response to the processor receiving the image signal from the infrared camera. The processor is further programmed to compare the image to at least one authorized image stored in the memory. The processor is further programmed to generate an actuation signal, in response to the processor determining that the image corresponds with the at least one authorized image. The actuator moves the lock device to the unlocked state, in response to the actuator receiving the actuation signal from the processor.

In one aspect, the body includes at least one of an A-pillar, a B-pillar, and a C-pillar, with the camera assembly attached to one of the A-pillar, the B-pillar, and the C-pillar.

In another aspect, the motor vehicle further includes a motor coupled to the processor, and the motor moves the door to the open position in response to the motor receiving the actuation signal from the processor.

In another aspect, the cosmetic panel includes a peripheral edge defining a perimeter and an intermediate portion spaced from the perimeter, with the single infrared camera attached to the intermediate portion such that the cosmetic panel covers the infrared camera.

In another aspect, the camera assembly further includes a header for attaching the single infrared camera to the intermediate portion of the cosmetic panel.

In another aspect, the camera assembly further includes an infrared illuminator disposed adjacent to the single infrared camera for emitting the infrared light through the intermediate portion of the cosmetic panel, such that an object facing the outboard side of the cosmetic panel reflects the infrared light back through intermediate portion to the infrared camera.

In another aspect, the cosmetic panel is a single-piece panel having an opacity that blocks visible light and a translucence for transmitting the infrared light.

In another aspect, the cosmetic panel is made of a poly(methyl methacrylate) (PMMA) material.

In another aspect, the cosmetic panel is a composite including germanium and/or silicon.

According to several aspects, a method of is provided for operating a camera assembly of a facial recognition system for a motor vehicle. The camera assembly includes a cosmetic panel having an outboard side and an inboard side facing the motor vehicle. The camera assembly further includes a single infrared camera adapted to be disposed adjacent to the inboard side of the cosmetic panel. The method includes the cosmetic panel transmitting an infrared light to the infrared camera. The method further includes the cosmetic panel blocking a visible light from the infrared camera. The method further includes the single infrared camera generating an image signal, in response to the single infrared camera receiving the infrared light transmitted through cosmetic panel.

In one aspect, a header attaches the single infrared camera to an intermediate portion of the cosmetic panel that is spaced from a perimeter of the cosmetic panel, such that the cosmetic panel covers the infrared camera.

In another aspect, an infrared illuminator emitting the infrared light through the intermediate portion of the cosmetic panel, such that an object facing the outboard side of the cosmetic panel reflects the infrared light back through the intermediate portion to the infrared camera.

In another aspect, a processor determines an image, in response to the processor receiving the image signal from the infrared camera. The processor compares the image to one or more authorized images stored in a memory. The processor generates an actuation signal, in response to the processor determining that the image corresponds with one or more of the authorized images. An actuator moves the lock device to the unlocked state, in response to the actuator receiving the actuation signal from the processor.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1 is a perspective view of one example of a motor vehicle having an A-pillar, a B-pillar, a C-pillar, and a facial recognition system with a camera assembly integrated in one or more of the pillars.

FIG. 2 is an exploded view of the camera assembly of FIG. 1.

FIG. 3 is a plan view of the camera assembly of FIG. 2.

FIG. 4 is a cross-sectional view of the camera assembly of FIG. 3, as taken along line 4-4.

FIG. 5 is a flow chart of one exemplary method of operating the facial recognition of FIG. 1.

### DETAILED DESCRIPTION

The following description is merely exemplary in nature and is not intended to limit the present disclosure, application, or uses. Although the drawings represent examples, the drawings are not necessarily to scale and certain features may be exaggerated to better illustrate and explain a particular aspect of an illustrative example. Any one or more of these aspects can be used alone or in combination within one another. Further, the exemplary illustrations described herein are not intended to be exhaustive or otherwise limiting or restricting to the precise form and configuration shown in the drawings and disclosed in the following detailed description. Exemplary illustrations are described in detail by referring to the drawings as follows:

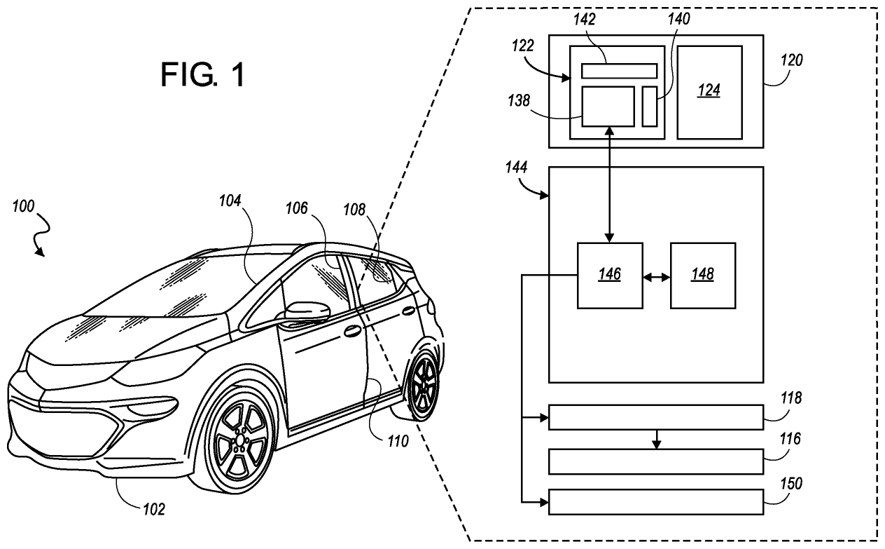

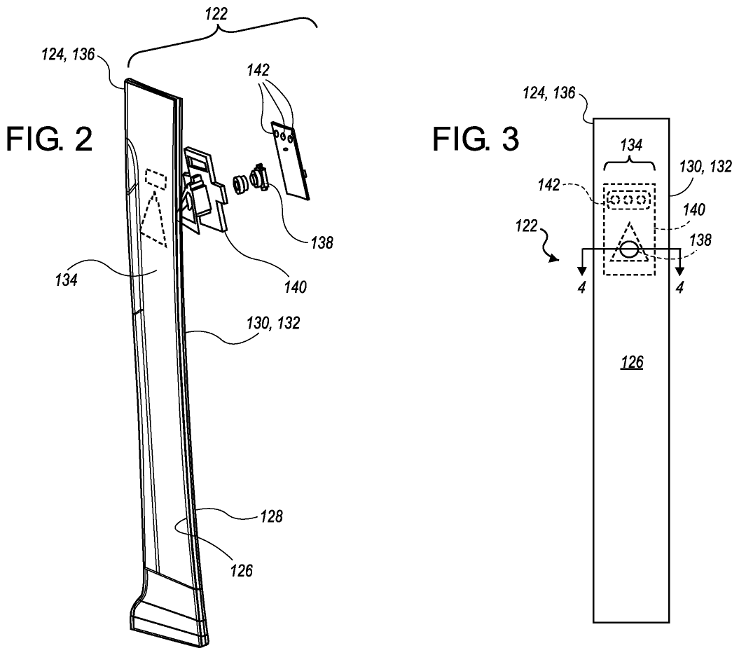

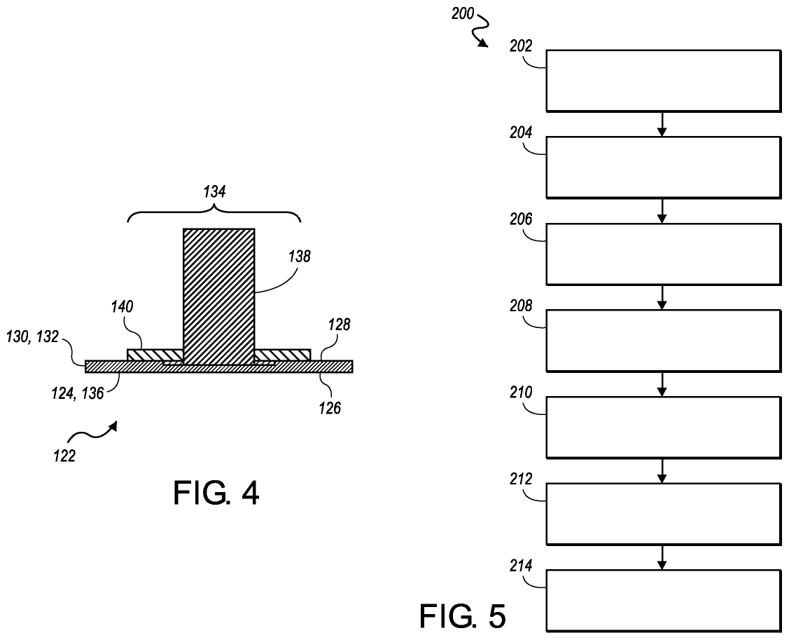

Referring to FIGS. 1 and 2, one example of a motor vehicle 100 includes a body 102 having an A-pillar 104, a B-pillar 106, and a C-pillar 108. The motor vehicle 100 further includes a door 110 attached to the body 102, with the door 110 movable between an open position 112 and a closed position 114. The motor vehicle 100 further includes a lock device 116 coupled to at least one of the door 110 and the body 102, with the lock device 116 being movable to a locked state for holding the door in the closed position and an unlocked state where the door is movable to the open position. The motor vehicle 100 further includes an actuator 118 for moving the lock device 116 between the locked and unlocked states. The motor vehicle 100 further includes a facial recognition system 120 including one or more camera assemblies 122 as described in detail below.

The camera assembly 122 is attached to one of the A-pillar 104, the B-pillar 106, and the C-pillar 108. While this example of the camera assembly 122 is integrated in the B-pillar, it is contemplated that the camera assembly can be integrated in the A-pillar, the C-pillar, a rear view mirror assembly, a reverse backup camera assembly, a brake light, other suitable portions of the vehicle, or any combination of the same. It is contemplated that the motor vehicle can have any number of camera assemblies. For instance, the motor vehicle can have a plurality of the camera assemblies for an associated one of doors, liftgates, trunk lids, hoods, compartment doors, or other closure panels.

As best shown in FIGS. 2 and 3, the camera assembly 122 includes a cosmetic panel 124 adapted to be attached to one of the door 110 and the body 102 (FIG. 1). The cosmetic panel 124 has an outboard side 126 and an inboard side 128 facing one of the door 110 and the body 102, with the cosmetic panel 124 being opaque to visible light and transmissive to an infrared light. The cosmetic panel 124 includes a peripheral edge 130 defining a perimeter 132 and an intermediate portion 134 spaced from the perimeter 132. The cosmetic panel 124 is a single-piece panel 136 having an opacity that blocks visible light and a translucence for transmitting the infrared light. The cosmetic panel 124 is made of a poly(methyl methacrylate) (PMMA) material. PMMA is also known as acrylic, acrylic glass, or plexiglass, as well as by the trade names CRYLUX, PLEXIGLAS, ACRYLITE, ASTARIGLAS, LUCITE, PERCLAX, and PERSPEX, among several others. PMMA is a transparent thermoplastic often used in sheet form as a lightweight or shatter-resistant alternative to glass. In other examples, the cosmetic panel is a composite including at least one of germanium, silicon, sapphire (crystalline alumina), yttria, yttrium aluminum garnet (YAG), opaque filters, e.g., Wratten 87, or other suitable materials.

The camera assembly 122 further includes a single infrared camera 138 adapted to be disposed adjacent to the inboard side 128 of the cosmetic panel 124 for generating an image signal, in response to the single infrared camera 138 receiving the infrared light transmitted through cosmetic panel 124. The camera assembly 122 further includes a header 140 for attaching the single infrared camera 138 to the intermediate portion 134 of the cosmetic panel 124, such that the cosmetic panel covers the infrared camera. It is contemplated that the camera assembly can have any suitable fastener for attaching the infrared camera to the vehicle and disposing the infrared camera adjacent to the intermediate portion of the cosmetic panel. The single infrared camera 138 is an infrared thermal imaging camera configured to capture thermal images in the spectrum of wavelengths from 800 nanometers to 2,500 nanometers with or without visible illumination. The single infrared camera 138 can detect thermal radiation from objects even in the lack of proper lighting and the presence of rain, snow, fog, smoke, and blowing sand or dust.

The camera assembly 122 further includes an infrared illuminator 142 or infrared light source disposed adjacent to the single infrared camera 138 for emitting the infrared light through the intermediate portion 134 of the cosmetic panel 124, such that an object, e.g. an individual's face, facing the outboard side 126 of the cosmetic panel 124 reflects the infrared light through intermediate portion 134 to the infrared camera 138.

The facial recognition system 120 further includes computer 144 having a processor 146 coupled to the infrared camera 138. The computer 144 further includes a memory 148 including instructions such that the processor 146 is programmed to determine an image, in response to the processor 146 receiving the image signal from the infrared camera 138. The processor 146 is further programmed to compare the image to at least one authorized image stored in the memory 148. The processor 146 is further programmed to generate an actuation signal, in response to the processor 146 determining that the image corresponds with one or more authorized images, and the actuator 118 moves the lock device 116 to the unlocked state, in response to the actuator 118 receiving the actuation signal from the processor 146. The facial recognition system 120 further includes a motor 150 coupled to the processor 146. The motor 150 moves the door 110 to the open position, in response to the motor 150 receiving the actuation signal from the processor 146. In this example, the processor 146 is an ECU of a Passive Entry Passive Start module (PEPS module), and the PEPS module and the associated facial recognition hardware and software may be native components of the motor vehicle adapted to communicate with the system 120 via a CAN interface. In other examples, the processor, the motor, the camera assembly, and other aforementioned components can be dedicated parts of a system that is independent from the PEPS module or other native systems of the vehicle.

Referring now to FIG. 5, a method 200 of operating the camera assembly 122 of the facial recognition system is provided. The method 200 commences at block 202 with the header 140 attaching the single infrared camera 138 to an intermediate portion 134 of the cosmetic panel 124 that is spaced from the perimeter 132 of the cosmetic panel 124, such that the cosmetic panel 124 covers the infrared camera 138.

At block 204, the infrared illuminator 142 emits the infrared light through the intermediate portion 134 of the cosmetic panel 124, such that an object, e.g. an individual's face, facing the outboard side 126 of the cosmetic panel 124 reflects the infrared light through intermediate portion 134 to the infrared camera 138. The cosmetic panel 124 blocks the transmission of light in the visible spectrum and allows the transmission of infrared light, such that the infrared camera 138 is concealed by the cosmetic panel 124.

At block 206, the processor 146 determines an image, in response to the processor 146 receiving the image signal from the infrared camera 138.

At block 208, the processor 146 compares the image to one or more authorized images stored in the memory 148.

At block 210, the processor 146 generates the actuation signal, in response to the processor 146 determining that the image corresponds one or more of the authorized images.

At block 212, the actuator 118 moves the locked device 116 to the unlocked state, in response to the actuator 118 receiving the actuation signal from the processor 146.

At block 214, the motor 150 moves the door 110 to the open position, in response to the motor 150 receiving the actuation signal from the processor 146.

The system 120 includes a computer 144 having the processor 146 and memory 148. Computers and computing devices generally include computer executable instructions, where the instructions may be executable by one or more computing devices such as those listed above. Computer executable instructions may be compiled or interpreted from computer programs created using a variety of programming languages and/or technologies. Some of these applications may be compiled and executed on a virtual machine. In general, the processor 146 (e.g., a microprocessor) receives instructions, e.g., from a memory 148, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory 148 may include a computer readable medium (also referred to as a processor readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A camera assembly for a facial recognition system of a motor vehicle, the camera assembly comprising:
a cosmetic panel adapted to be attached to the motor vehicle, the cosmetic panel having an outboard side and an inboard side facing the motor vehicle, with the cosmetic panel being opaque to visible light and transmissive to an infrared light; and
a single infrared camera adapted to be disposed adjacent to the inboard side of the cosmetic panel for generating an image signal in response to the single infrared camera receiving the infrared light transmitted through cosmetic panel.

2. The camera assembly of claim 1 wherein the cosmetic panel includes a peripheral edge defining a perimeter and an intermediate portion spaced from the perimeter, with the single infrared camera attached to the intermediate portion such that the cosmetic panel covers the infrared camera.

3. The camera assembly of claim 2 further comprising a header for attaching the single infrared camera to the intermediate portion of the cosmetic panel.

4. The camera assembly of claim 3 further comprising an infrared illuminator disposed adjacent to the single infrared camera for emitting the infrared light through the intermediate portion of the cosmetic panel, such that an object facing the outboard side of the cosmetic panel reflects the infrared light through intermediate portion to the infrared camera.

5. The camera assembly of claim 4 wherein the cosmetic panel comprises a single-piece panel having an opacity that blocks visible light and a translucence for transmitting the infrared light.

6. The camera assembly of claim 5 wherein the cosmetic panel comprises a poly(methyl methacrylate) (PMMA) material.

7. The camera assembly of claim 5 wherein the cosmetic panel comprises a composite including at least one of germanium and silicon.

8. A motor vehicle comprising:
a body;
a door attached to the body and movable between open and closed positions;
a lock device coupled to at least one of the door and the body, with the lock device movable to a locked state for holding the door in the closed position and an unlocked state where the door is movable to the open position;
an actuator for moving the lock device between the locked and unlocked states; and
a facial recognition system comprising:
a camera assembly including:
a cosmetic panel adapted to be attached to one of the door and the body, the cosmetic panel having an outboard side and an inboard side facing one of the door and the body, with the cosmetic panel being opaque to visible light and transmissive to an infrared light; and
a single infrared camera adapted to be disposed adjacent to the inboard side of the cosmetic panel for generating an image signal in response to the single infrared camera receiving the infrared light transmitted through cosmetic panel;
a processor coupled to the infrared camera;
a memory including instructions such that the processor is programmed to:
determine an image in response to the processor receiving the image signal from the infrared camera;
compare the image to at least one authorized image stored in the memory; and
generate an actuation signal in response to the processor determining that the image corresponds with the at least one authorized image;
wherein the actuator moves the lock device to the unlocked state in response to the actuator receiving the actuation signal from the processor.

9. The motor vehicle of claim 8 wherein the body comprises at least one of an A-pillar, a B-pillar, and a C-pillar, with the camera assembly attached to one of the A-pillar, the B-pillar, and the C-pillar.

10. The motor vehicle of claim 9 further comprising a motor coupled to the processor, and the motor moves the door to the open position in response to the motor receiving the actuation signal from the processor.

11. The motor vehicle of claim 9 wherein the cosmetic panel includes a peripheral edge defining a perimeter and an intermediate portion spaced from the perimeter, with the single infrared camera attached to the intermediate portion such that the cosmetic panel covers the infrared camera.

12. The motor vehicle of claim 11 wherein the camera assembly further comprises a header for attaching the single infrared camera to the intermediate portion of the cosmetic panel.

13. The motor vehicle of claim 12 wherein the camera assembly further comprises an infrared illuminator disposed adjacent to the single infrared camera for emitting the infrared light through the intermediate portion of the cosmetic panel, such that an object facing the outboard side of the cosmetic panel reflects the infrared light through intermediate portion to the infrared camera.

14. The motor vehicle of claim 13 wherein the cosmetic panel comprises a single-piece panel having an opacity that blocks visible light and a translucence for transmitting the infrared light.

15. The motor vehicle of claim 14 wherein the cosmetic panel comprises a poly(methyl methacrylate) (PMMA) material.

16. The motor vehicle of claim 14 wherein the cosmetic panel comprises a composite including at least one of germanium and silicon.

17. A method of operating a camera assembly of a facial recognition system for a motor vehicle, the camera assembly including a cosmetic panel having an outboard side and an inboard side facing the motor vehicle, and the camera assembly further including a single infrared camera adapted to be disposed adjacent to the inboard side of the cosmetic panel, the method comprising:
transmitting, using the cosmetic panel, an infrared light to the infrared camera;
blocking, using the cosmetic panel, a visible light from the infrared camera; and
generating, using the infrared camera, an image signal in response to the single infrared camera receiving the infrared light transmitted through cosmetic panel.

18. The method of claim 17 further comprising:
attaching, using a header, the single infrared camera to an intermediate portion of the cosmetic panel that is spaced from a perimeter of the cosmetic panel; and
covering, using the cosmetic panel, the infrared camera.

19. The method of claim 18 further comprising emitting, using an infrared illuminator, the infrared light through the intermediate portion of the cosmetic panel, such that an object facing the outboard side of the cosmetic panel reflects the infrared light through intermediate portion to the infrared camera.

20. The method of claim 19 further comprising:
determining, using a processor, an image in response to the processor receiving the image signal from the infrared camera;
comparing, using the processor, the image to at least one authorized image stored in a memory;
generating, using the processor, an actuation signal in response to the processor determining that the image corresponds with the at least one authorized image; and
moving the locked device to the unlocked state in response to the lock device receiving the actuation signal from the processor.
